(19) United States
(12) Patent Application Publication
(10) Pub. No.: US 2019/0277252 A1
(43) Pub. Date: Sep. 12, 2019

(54) Systems and Methods for Maximizing Wind Energy

(71) Applicant: Saudi Arabian Oil Company, Dhahran (SA)

(72) Inventors: Mohamed Y. Haj-Maharsi, Dhahran (SA); Abdulaziz A. Altalhi, Dhahran (SA)

(21) Appl. No.: 15/918,687

(22) Filed: Mar. 12, 2018

(51) Int. Cl. F03D 3/06; F03D 3/00; F03D 7/06; F03D 9/25

(52) U.S. Cl. CPC F03D 3/067; F03D 9/25; F03D 7/06; F03D 3/005

(57) ABSTRACT

A vertical axis wind turbine (VAWT) system includes a pillar having a vertical rotational axis, a plurality of blades connected to the pillar, each of the plurality of blades comprising a plurality of flaps that open or close in response to a wind direction, and a control system configured to control the extent of opening and closing of the flaps based on the wind direction and wind intensity. A method for maximizing energy harvesting in a VAWT includes providing a pillar having a vertical rotational axis, connecting a plurality of blades to the pillar, each of the plurality of blades comprising a plurality of flaps that open or close in response to a wind direction, and connecting a control system to the plurality of blades, the control system configured to control the extent of opening and closing of the flaps based on the wind direction and wind intensity.

### TECHNICAL FIELD

Example embodiments generally relate to the transformation of fluid flow energy and, more specifically, to the usage of wind energy to provide a renewable source of mechanical or electrical power.

### BACKGROUND

Wind turbines convert wind energy into electricity. The two main types of wind turbines include the horizontal-axis wind turbines and the vertical-axis wind turbines. The current models of practically used wind-driven engines fall in two main categories: propeller systems with horizontal axis of rotation also known as horizontal axis wind turbines (HAWT) and vertical axis wind turbines (VAWT). The later have the advantage of more economic use of ground (or water) area, lower cost and easier maintenance. One advantage of VAWT systems is that the turbine doesn't need to be pointed into the wind. Another advantage of the VAWT arrangement is that the generator and/or gearbox can be placed at the bottom, near the ground, so the tower doesn't need to support it.

The two main types of vertical axis wind turbines include one type having rotating blades without lift generating surfaces and include the Darreius-type having rotating blades with lift generating airfoils (VAWT). The HAWT typically has a rotor and blades with lifting surfaces mounted on a horizontal-axis and directed upwind atop a tower. Wind energy incident to the blades rotates the rotor, and a gearbox and other components are connected to the rotor communicate the rotation to an electric generator that converts the rotation to electrical energy. To be effective, the blades must be directed relative to the direction of the wind. Therefore, the HAWT typically has a yaw mechanism to allow the blades to rotate around the tower. Because the blades are upwind of the tower, they must be made of rigid, strong material so they cannot be bent back by the wind and hit the tower. Requiring more rigid materials, the blades are more expensive to manufacture and are heavy. In addition, the tower's yaw mechanism must be strong so it can determine the direction of the wind direction and orient the blades into the direction of the wind. Finally, the tower must also be strong so it can support the heavy rotor, gear-box, generator, and other equipment on top of the tower. Therefore, the tower requires more materials, is more expensive to build, and is heavy. Overall, the HAWT is a rigid wind turbine, requires more materials, is heavy, and has a high center of gravity. In addition, it needs to be oriented to face the wind, and requires a firm foundation or platform. Therefore, it is very expensive to build a floating platform to support the HAWT, which is heavy, has a high center of gravity, and requires a very stable platform.

By contrast, the conventional VAWT uses a rotor that runs vertically from the ground and has curved blades connected at the rotor's ends. This vertical rotor sits on a bearing and gearbox component and drives an electric generator. Unlike the HAWT, the VAWT is omni-directional and does not need to be oriented into the wind. In addition, the VAWT has a low center of gravity with its heavy components such a gearbox, generator, braking and control system positioned near the ground. Therefore, the VAWT does not require an as rigid rotor as with the HAWT's tower to support these components. The HAWTs have been widely used in land-based windfarms around the world. HAWTs have also been used in offshore windfarms in Europe. A conventional offshore HAWT has the conventional components of a rotor and blades supported horizontally on a vertical tower. These conventional components rest on a fixed support rigidly affixed to the sea floor.

United States Patent Application 2009/0072544 discloses an offshore wind turbine with a VAWT mounted on a platform. The VAWT has a vertical rotor and curved blades coupled to a gearbox and an electric generator. The VAWT can fixedly extend from the platform or may be capable of reclining on the platform either manually or automatically. The platform can be composed of modular elements coupled together. Offshore, the platform can be semi-submersible with the VAWT extending out of the water and with a counterbalance extending below the platform. Alternatively, the platform can float on the water's surface and can have several arms that extend outwardly from the VAWT to increase the platform's footprint. To anchor the turbine offshore, anchoring systems can anchor the platform to the seabed while allowing the floating wind turbine to adjust passively or actively to changes in sea level due to tidal variations or storm swells.

The amount of electrical power generated by wind turbines, which convert mechanical energy to electrical energy, is heavily attributed to the design of blades, which convert wind flow into mechanical rotation to drive an electrical generator and produce electrical power. Different types of blade designs provide different ways to harness wind energy. Blade shapes, weights, and materials impact the efficiency of wind turbines and their cost of energy. In order to achieve the same power output of a conventional VAWT under the same wind condition but with smaller wind turbine size a radical change in the blade design is required. Electrical energy produced by wind turbines is directly related to the design of windmills. With windmills design enhancements, wind energy can be harvested more efficiently.

In a conventional design of a VAWT, however, the wind pushes blades on both sides of the vertical rotational axe of the turbine and causes a rotation that is proportional to the difference of forces applied.

### SUMMARY

In order to increase the rotational torque for the same amount of wind, the resulting force applied on the blades causing the rotation should increase. This can be realized by dynamically reducing the surface of the passive blades, for example, blades that are resisting the rotation. In this document, a new innovative blade design to maximize the utilization of wind energy in a vertical wind turbine is proposed. The innovative design allows the wind force to be concentrated on the active blades of the wind turbine for increased torque while the passive blades impact is reduced. In this document, a novel wind turbine blade design that inherently boosts the amount of harvested wind energy and increases the wind turbine efficiency is disclosed.

Wind turbine blades are featured with flaps that open and close depending on the wind direction. The degree of opening or closing of the flaps, however, depends on a spring resistor connecting a camshaft to the wind turbine blade. The camshaft is fixed to a pillar inside the blades support, and the pillar is connected to a wind tale to rotate the camshaft following wind directions, and allowing opening and closing with the specified degree determined by the resistance of the spring resistor.

Accordingly, one example embodiment is a vertical axis wind turbine (VAWT) system including a pillar having a vertical rotational axis, a plurality of blades connected to the pillar, each of the plurality of blades comprising a plurality of flaps that open or close in response to a wind direction, and a control system configured to control the extent of opening and closing of the flaps based on the wind direction and wind intensity. The VAWT system further includes a camshaft connected to the plurality of blades by means of a spring resistor, the camshaft configured to open or close the flaps based on the resistance of the spring resistor. The camshaft is connected to the pillar supporting the plurality of blades. The VAWT system further includes a power generator connected to the vertical rotational axis of the pillar to generate power based on the rotation of the blades, and store the power. The VAWT system may also include an electrical system substation connected to the power generator by a plurality of power lines. The plurality of blades may be made from metal, fiber reinforced composite, or a polymeric material. Alternatively or additionally, the plurality of flaps are made from metal, fiber reinforced composite, or a polymeric material. The resistance of the spring resistor is less than 0.01 lbf. The plurality of flaps may be rectangular, circular, triangular, oval, or square shaped.

Another example embodiment is a method for maximizing energy harvesting in a vertical axis wind turbine (VAWT). The method may include providing a pillar having a vertical rotational axis, connecting a plurality of blades to the pillar, each of the plurality of blades comprising a plurality of flaps that open or close in response to a wind direction, and connecting a control system to the plurality of blades, the control system configured to control the extent of opening and closing of the flaps based on the wind direction and wind intensity. The method may also include connecting a camshaft to the plurality of blades by means of a spring resistor, the camshaft configured to open or close the flaps based on the resistance of the spring resistor. The method may further include connecting the camshaft to the pillar supporting the plurality of blades. The method may also include connecting a power generator to the vertical rotational axis of the pillar to generate power based on the rotation of the blades, and store the power, and connecting an electrical system substation to the power generator using a plurality of power lines. The plurality of blades may be made from metal, fiber reinforced composite, or a polymeric material. Alternatively or additionally, the plurality of flaps are made from metal, fiber reinforced composite, or a polymeric material. The resistance of the spring resistor is less than 0.01 lbf. The plurality of flaps may be rectangular, circular, triangular, oval, or square shaped.

### BRIEF DESCRIPTION OF THE DRAWINGS

So that the manner in which the features, advantages and objects of the example embodiments, as well as others which may become apparent, are attained and can be understood in more detail, more particular description of the example embodiments briefly summarized above may be had by reference to the embodiment which is illustrated in the appended drawings, which drawings form a part of this specification. It is to be noted, however, that the drawings illustrate only example embodiments and is therefore not to be considered limiting of its scope as the invention may admit to other equally effective embodiments.

FIG. 1A shows a top view of a multi-matrix turbine in one embodiment of a multi-matrix Vertical Axis Wind Turbine.

FIG. 1B shows a side view of a multi-flap matrix sail in one embodiment of a multi-matrix Vertical Axis Wind Turbine.

FIG. 2 is a schematic of a vertical axis wind turbine (VAWT) system, according to one or more example embodiments of the disclosure.

FIG. 3 is a schematic of another VAWT system, according to one or more example embodiments of the disclosure.

FIG. 4A is an isometric view of a VAWT system, according to one or more example embodiments of the disclosure.

FIG. 4B is a top view of the VAWT system shown in FIG. 4A, according to one or more example embodiments of the disclosure.

FIG. 4C is a cross-sectional view of the VAWT system shown in FIG. 4A, according to one or more example embodiments of the disclosure.

FIG. 5 illustrates example steps in a method for maximizing harvesting of wind energy in a VAWT, according to one or more example embodiments of the disclosure.

### DETAILED DESCRIPTION

The methods and systems of the present disclosure may now be described more fully with reference to the accompanying drawings in which embodiments are shown. The methods and systems of the present disclosure may be in many different forms and should not be construed as limited to the illustrated embodiments set forth in this disclosure; rather, these embodiments are provided so that this disclosure may be thorough and complete, and may fully convey its scope to those skilled in the art. Like numbers refer to like elements throughout.

Embodiments of wind turbines disclosed herein preferably comprise vertical-axis wind turbines (VAWTs) mounted on platforms. The VAWTs can be Darrieus-type with or without guy cables and can be mounted on floating or fixed platforms. The VAWT has a vertical rotor with curved or straight blades coupled to a gearbox and an electric generator. Alternatively, the VAWT can have a direct-drive generator without the gearbox. The vertical rotor can fixedly extend from the floating or non-floating platform or may be tilted down to rest on the platform either manually or automatically. The platform is preferably buoyant so it can be floated to a desired destination offshore and towed back to the service beach for repairs and maintenance.

For deeper water, the platform can be a semi-submersible barge with the VAWT extending out of the water and with a counterbalance extending below the platform to counterbalance the wind force against the wind turbine. For shallower water that may not accommodate the vertical extent of a counter balance, the platform can float on the water's surface like a barge. Preferably, the barge is heavy and constructed with low-cost reinforced concrete. To minimize the use of materials, the barge is preferably not rectangular or circular shape and instead has a cross-shape or star-shape with three or more arms. For example, the barge is preferably constructed with extended horizontal reaches to fasten guy cables, to counter-balance the wind force against the wind turbine, and to keep the platform stable. In addition, to extend its horizontal reaches, each of its arms can have a horizontal extender with a flotation tank at its end to increase stability.

For even shallower waters near shore, the VAWT on a floating platform can be built with heavy but low-cost materials, such as reinforced concrete, and can be built and assembled on the beach, pushed into the sea, and towed to the site. By filling its flotation tanks with water, the floating platform can be lowered into the water to rest directly onto the seabed, lake bed, or river bed. In this way, the platform can serve as a fixed platform or foundation for the VAWT during normal operation, while the vertical rotor and blades of the VAWT extend above the water's surface. The platform can be re-floated by pumping the water out of the flotation tanks so the VAWT and platform can be towed back to the beach for repairs and maintenance. The ability to refloat the platform and tow it for repairs can greatly reduce the cost of assembly, installation, repairs, and maintenance when compared to performing these activities at sea.

Various anchoring systems can be used for anchoring the platforms intended to float on or near the water's surface, including the catenary anchoring system and the tension-leg anchoring system that are often used in the offshore industry for anchoring oil and gas drilling and production floating platforms. Some of these anchoring systems can have weights and pulleys that anchor the platform to the seabed but allow the floating wind turbine to adjust passively to changes in sea level due to tidal variations or storm swells. In some embodiments, the anchoring systems do not rigidly affix the platforms to the seabed, but instead merely rest on the seabed, which eases installation and removal of the VAWTs.

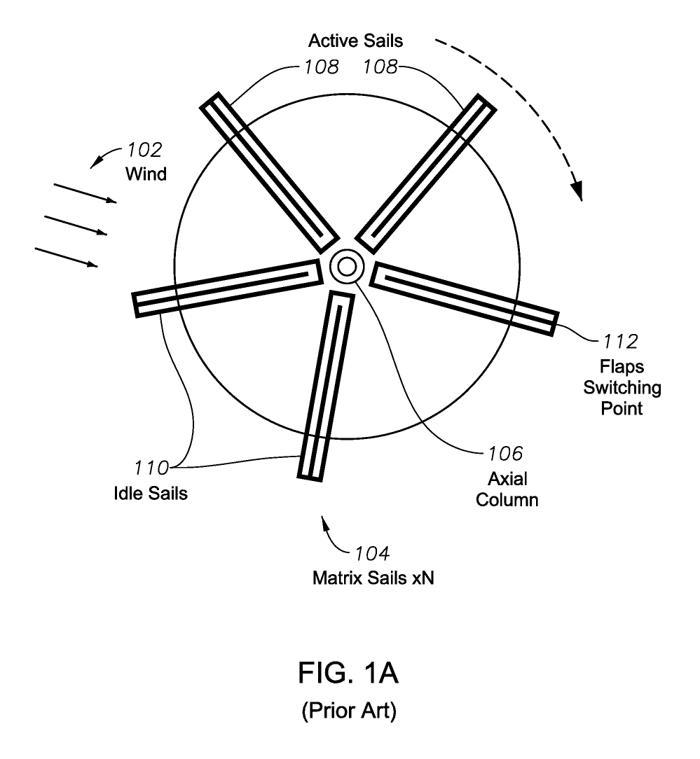

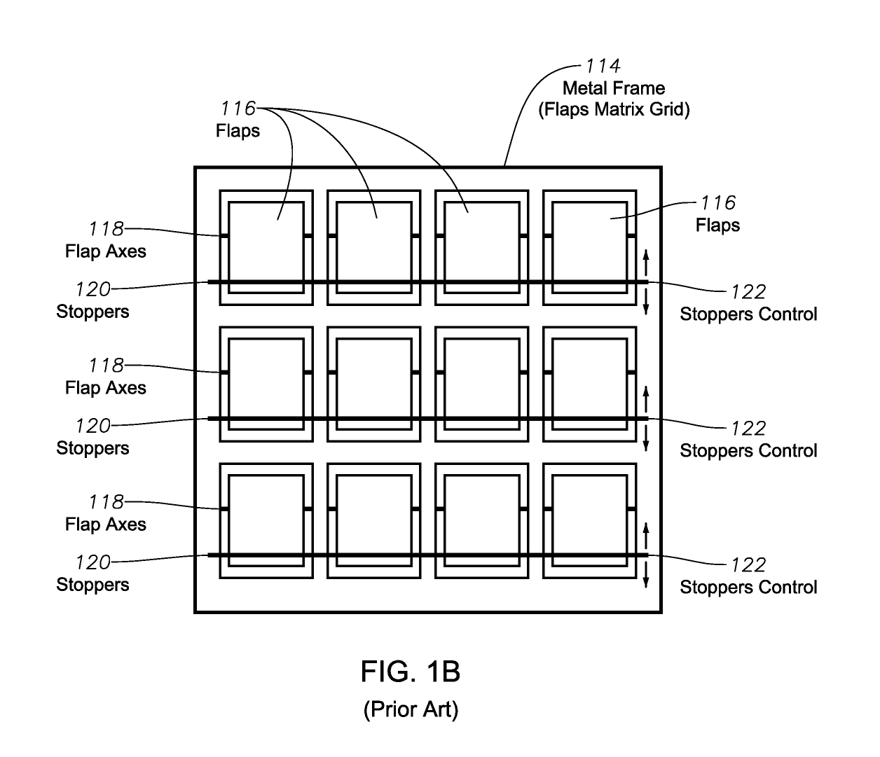

FIGS. 1A-1B show various views of a multi-matrix VAWT. FIG. 1A is a top view of a multi-matrix turbine, and FIG. 1B is a side view of a multi-flap matrix sail, for example. Referring initially to FIG. 1A, a wind flow 102 hits the wind turbine consisting of a number of sail panels 104 rotating around the vertical axis (axial column) 106. At any given time some of the sail panels 104 are active, e.g. panels 108 (flaps closed), and provide significant rotating torque, while some panels, e.g. panels 110, are idle because their flaps are open and the wind flow comes thru these panels without any significant resistance. Flaps change their status when the sail panel and its flap axes are positioned along the flow. This is designated on FIG. 1A as “flaps switching point” 112.

As shown in FIG. 1B, each sail panel consists of a metal frame 114 carrying a number of flaps 116 (elementary flap panels) rotating on elementary axes 118. Size of the openings in the panel grid 114 allows flaps 116 to rotate freely without any constraint. Sail panel frame 114 is also fitted with relatively long stoppers 120 in a direction parallel to the elementary axes 118, which can be shifted in the vertical direction to the upper (work) position or lower (idle) position. Stoppers 120 are offset from the centers of the flaps 116 so that each of the flaps can rotate free until its wider side touches the corresponding stopper, if the stopper is in the upper position. Shifting down stopper controls 122 allows full release of flaps, thus completely inactivating the particular row of sail panel matrix. This provides the adaptation means for the wide range of wind speeds from light breeze up to the gale force. One limitation of such a sail panel, however, is that the work position and idle position of the flaps cannot be individually controlled based on the direction or intensity of the wind.

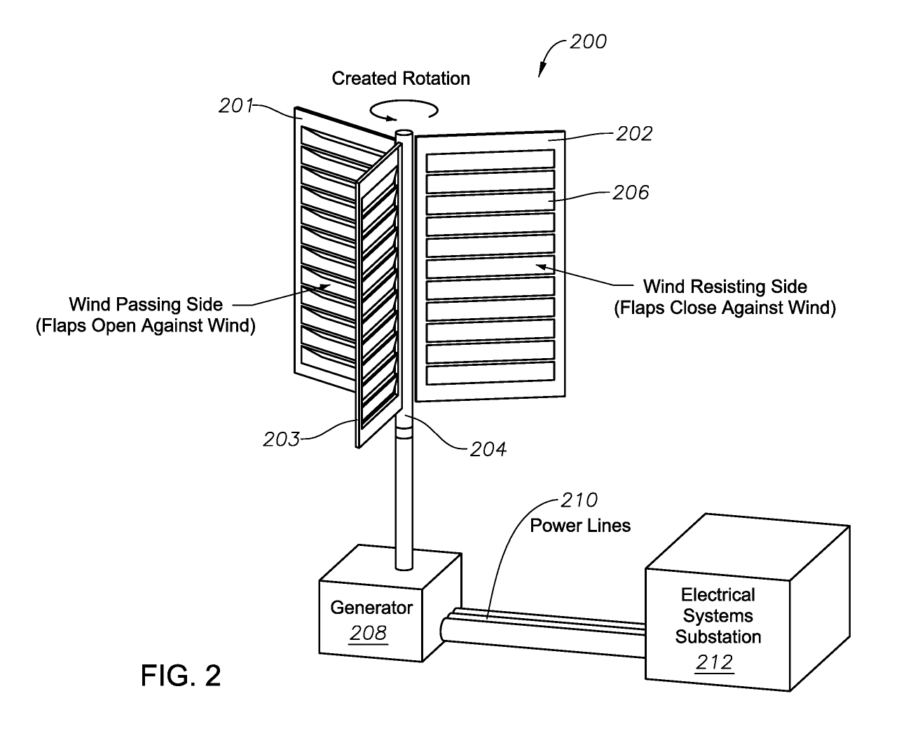

Turning now to FIG. 2, shown is a VAWT system 200 including three blades 201, 202, 203, according to one or more example embodiments of the present disclosure. Although only three blades are illustrated in these figures, it may be apparent to one of ordinary skill in the art that any number of blades may be used in the system. Each blade 201, 202, 203 is connected to a vertical rotational axis or pillar 204 that rotates based on the rotation of the blades 201, 202, 203. Each blade 201, 202, 203 contains a number of flaps 206 that can open only on one side of the system 200 as shown in FIG. 2. The vertical rotating axis or pillar 204 is connected to an electrical generator 208 that is connected to a power line 210 to output power to an electrical system substation 212.

As wind blows through the blades 201, 202, 203, the flaps 206 of the blade 202 located on the right-side of the rotational vertical axis 204 are pushed to a close position as depicted in FIG. 2. This causes a maximum push from the wind on this blade 202. On the left-side of the rotational vertical axis 204 the flaps 206 of the blade 201 are pushed to an open position which allows wind to pass through the openings and results in a reduced push from the wind on blade 201. As the right-side blade 202 rotates by 180 degrees, counterclockwise, due to the wind force, the flaps 206 may start to open and it may reach its maximum opening in the far left, allowing wind to pass through. Vice versa, as the left-side blade 201 rotates by 180 degrees, counterclockwise, the flaps may start to close and it may be fully closed in the far right, blocking wind from passing through.

The degree of opening and closing of the flaps 206 depends on a spring resistor connecting a camshaft to the wind turbine blade. The camshaft is fixed to the pillar inside the blade support, for example. This pillar is connected to a wind tale to rotate the camshaft following wind directions, and allow opening and closing with the specified degree determined by the resistance of the spring resistor.

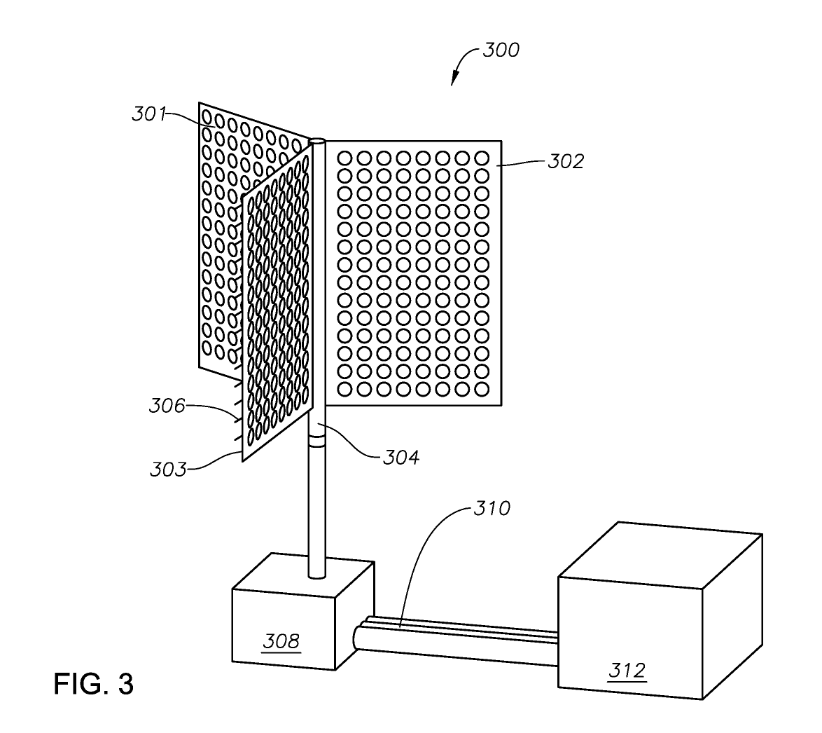

The above scenario may result in a higher wind force on the right side blade than that on the left side blade. The design can substitute flaps 206 by other mechanisms like micro-openings that open and close based on the side of the blade as depicted in FIG. 3, for example. The flaps 306 covering micro-openings open and close depending on the wind direction. FIG. 3 shows is a VAWT system 300 including three blades 301, 302, 303, according to one or more example embodiments of the present disclosure. Although only three blades are illustrated in these figures, it may be apparent to one of ordinary skill in the art that any number of blades may be used in the system. Each blade 301, 302, 303 is connected to a vertical rotational axis or pillar 304 that rotates based on the rotation of the blades 301, 302, 303. Each blade 301, 302, 303 contains a number of flaps 306 that can open only on one side of the system 300 as shown in FIG. 3. The vertical rotating axis or pillar 304 is connected to an electrical generator 308 that is connected to a power line 310 to output power to an electrical system substation 312.

As wind blows through the blades 301, 302, 303, the flaps 306 of the blade 302 located on the right-side of the rotational vertical axis 304 are pushed to a close position as depicted in FIG. 3. This causes a maximum push from the wind on this blade 302. On the left-side of the rotational vertical axis 304 the flaps 306 of the blade 301 are pushed to an open position which allows wind to pass through the openings and results in a reduced push from the wind on blade 301. As the right-side blade 302 rotates by 180 degrees, counterclockwise, due to the wind force, the flaps 306 may start to open and it may reach its maximum opening in the far left, allowing wind to pass through. Vice versa, as the left-side blade 301 rotates by 180 degrees, counterclockwise, the flaps may start to close and it may be fully closed in the far right, blocking wind from passing through.

The degree of opening and closing of the flaps 306 depends on a spring resistor connecting a camshaft to the wind turbine blade. The camshaft is fixed to the pillar inside the blades support, for example. This pillar is connected to a wind tale to rotate the camshaft following wind directions, and allow opening and closing with the specified degree determined by the resistance of the spring resistor.

Accordingly, one example embodiment is a vertical axis wind turbine (VAWT) system including a pillar having a vertical rotational axis, a plurality of blades connected to the pillar, each of the plurality of blades comprising a plurality of flaps that open or close in response to a wind direction, and a control system configured to control the extent of opening and closing of the flaps based on the wind direction and wind intensity. The VAWT system further includes a camshaft connected to the plurality of blades by means of a spring resistor, the camshaft configured to open or close the flaps based on the resistance of the spring resistor. The camshaft is connected to the pillar supporting the plurality of blades. The VAWT system further includes a power generator connected to the vertical rotational axis of the pillar to generate power based on the rotation of the blades, and store the power. The VAWT system may also include an electrical system substation connected to the power generator by a plurality of power lines. The plurality of blades may be made from metal, fiber reinforced composite, or a polymeric material. Alternatively or additionally, the plurality of flaps are made from metal, fiber reinforced composite, or a polymeric material. The resistance of the spring resistor is less than 0.01 lbf. The plurality of flaps may be rectangular, circular, triangular, oval, or square shaped.

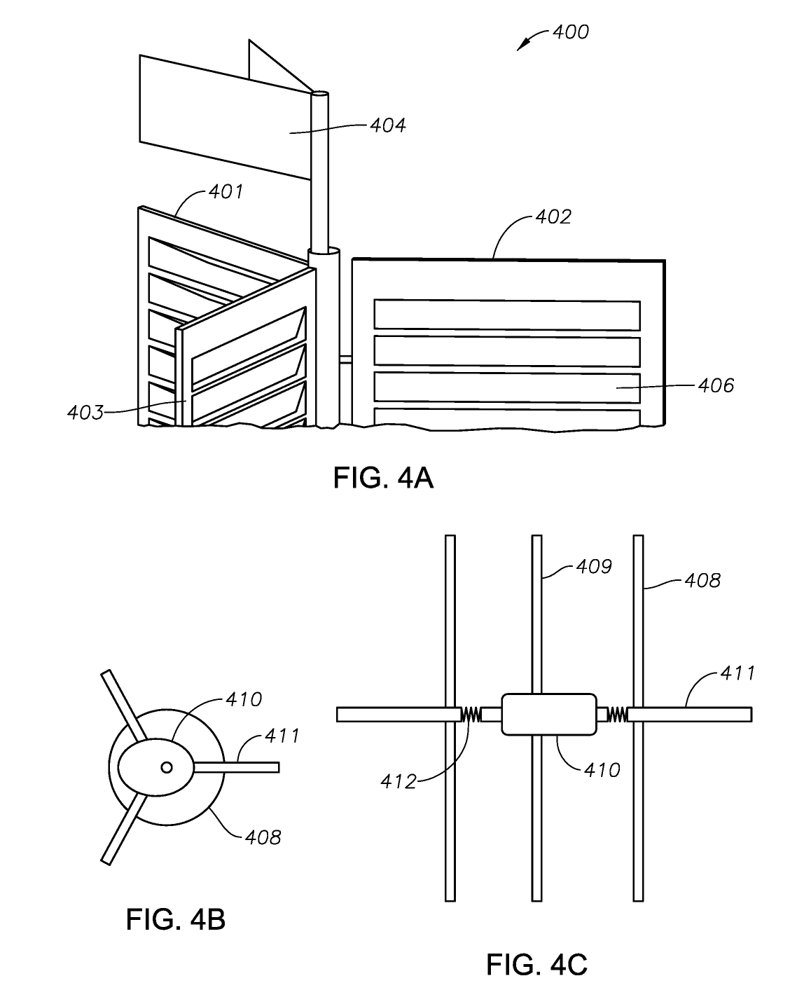

FIG. 4A is an isometric view of a VAWT system 400, according to one or more example embodiments of the disclosure. As illustrated in this figure, outer cylinder 408 rotates around a pillar 409 with a vertical rotational axis. The pillar 409 has a camshaft 410 fixed to it, which rotates with the pillar 409. Rods 411 are connected to blades 401, 402, 403 and rotate with outer cylinder 408. A spring mechanism, such as a spring resistor 412 maintains the rods 411 to be always in contact with the camshaft 410. Therefore, when the outer cylinder 408 rotates, the rods 411 translate in and out, and push the flaps 406 to open or close depending on the position of the outer cylinder 408 versus the pillar 409. As the wind direction changes, pillar 409 will be following the position of the tale 404. As the winds blows, the pillar 409 supporting the tale 404 will act like a camshaft 410 that will provide control on the level of speed and torque the wind turbine blades 401, 402, 403 rotate at. FIG. 4B is a top view of the VAWT system 400 shown in FIG. 4A, and FIG. 4C is a cross-sectional view of the VAWT system 400 shown in FIG. 4A, according to one or more example embodiments of the disclosure. As the right-side blade 402 rotates by 180°, counterclockwise, due to the wind force, the flaps 406 will start to open and it will reach its maximum opening in the far left, allowing wind to pass through. Vice versa, as the left-side blade 401 rotates by 180°, counterclockwise, the flaps 406 will start to close and it will be fully closed in the far right, blocking wind from passing through. A camshaft mechanism, such as that illustrated in FIGS. 4A-4C, is used to control the movement of the flaps 406.

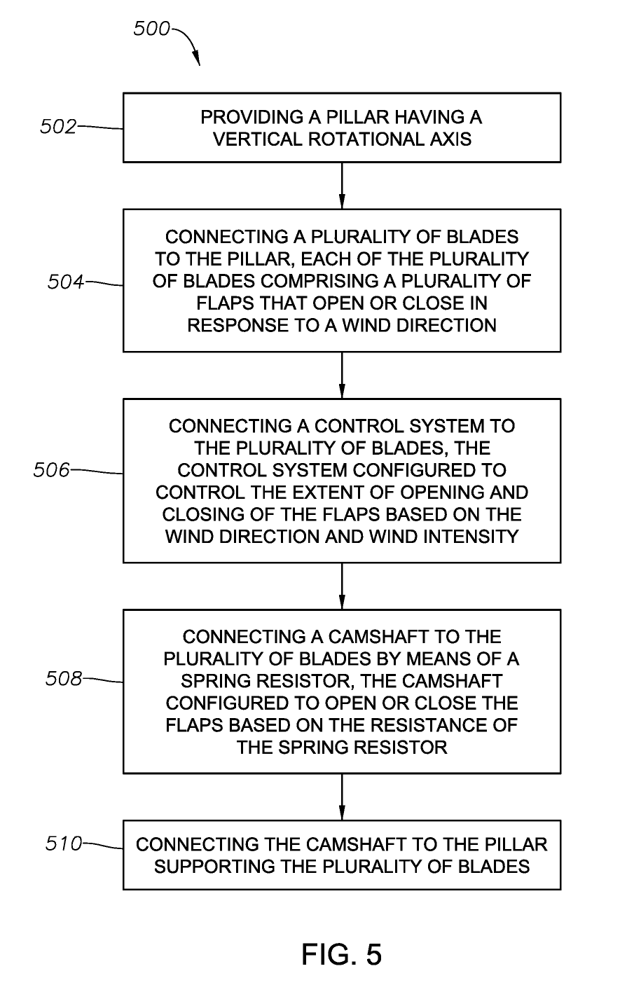

FIG. 5 illustrates example steps in a method 500 for maximizing harvesting of wind energy in a VAWT, according to one or more example embodiments of the disclosure. At step 502, the method may include providing a pillar having a vertical rotational axis. At step 504, the method may include connecting a plurality of blades to the pillar, each of the plurality of blades comprising a plurality of flaps that open or close in response to a wind direction. At step 506, the method may include connecting a control system to the plurality of blades, the control system configured to control the extent of opening and closing of the flaps based on the wind direction and wind intensity. The method 500 may also include connecting a camshaft to the plurality of blades by means of a spring resistor, the camshaft configured to open or close the flaps based on the resistance of the spring resistor, at step 508. The method 500 may further include connecting the camshaft to the pillar supporting the plurality of blades, at step 510. The method may optionally include connecting a power generator to the vertical rotational axis of the pillar to generate power based on the rotation of the blades, and store the power, and connecting an electrical system substation to the power generator using a plurality of power lines. The plurality of blades may be made from metal, fiber reinforced composite, or a polymeric material. Alternatively or additionally, the plurality of flaps are made from metal, fiber reinforced composite, or a polymeric material. The resistance of the spring resistor is less than 0.01 lbf. The plurality of flaps may be rectangular, circular, triangular, oval, or square shaped.

One advantage of the example embodiments disclosed is that the sails of the VAWT do not need to be oriented toward the wind's direction, and the VAWT's rotor and blades can be constructed mainly of composites or other lightweight, corrosion-resistant materials. In addition, the rotor and blades can be built with a low profile over the water so that the offshore wind turbine can have a lower center of gravity, unlike offshore HAWTs that must support the heavy rotor, blades, gearbox, generator, and tower high above the water. At the height of 50 meters, for example, the wind over the sea may be significantly greater than the wind over land, so the VAWT on the offshore wind turbine can have greater energy output than its land-based counterparts.

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

Conditional language, such as, among others, “can,” “could,” “might,” or “may,” unless specifically stated otherwise, or otherwise understood within the context as used, is generally intended to convey that certain implementations could include, while other implementations do not include, certain features, elements or operations. Thus, such conditional language generally is not intended to imply that features, elements or operations are in any way required for one or more implementations or that one or more implementations necessarily include logic for deciding, with or without user input or prompting, whether these features, elements or operations are included or are to be performed in any particular implementation.

The systems and methods described, therefore, are well adapted to carry out the objects and attain the ends and advantages mentioned, as well as others that may be inherent. While example embodiments of the system and method has been given for purposes of disclosure, numerous changes exist in the details of procedures for accomplishing the desired results. These and other similar modifications may readily suggest themselves to those skilled in the art, and are intended to be encompassed within the spirit of the system and method disclosed and the scope of the appended claims.

1. A vertical axis wind turbine (VAWT) system comprising:
a pillar having a vertical rotational axis;
a plurality of blades connected to the pillar, each of the plurality of blades comprising a plurality of flaps that open or close in response to a wind direction; and
a control system configured to control the extent of opening and closing of the flaps based on the wind direction and wind intensity.

2. The VAWT system of claim 1, wherein the control system further comprises:
a camshaft connected to the plurality of blades by means of a spring resistor, the camshaft configured to open or close the flaps based on the resistance of the spring resistor.

3. The VAWT system of claim 1, wherein the camshaft is connected to the pillar supporting the plurality of blades.

4. The VAWT system of claim 1, further comprising:
a power generator connected to the vertical rotational axis of the pillar to generate power based on the rotation of the blades, and store the power.

5. The VAWT system of claim 1, further comprising:
an electrical system substation connected to the power generator by a plurality of power lines.

6. The VAWT system of claim 1, wherein the plurality of blades are made from metal, fiber reinforced composite, or a polymeric material.

7. The VAWT system of claim 1, wherein the plurality of flaps are made from metal, fiber reinforced composite, or a polymeric material.

8. The VAWT system of claim 2, wherein the resistance of the spring resistor is less than 0.01 lbf.

9. The VAWT system of claim 1, wherein the plurality of flaps are rectangular, circular, triangular, oval, or square shaped.

10. A method for maximizing energy harvesting in a vertical axis wind turbine (VAWT), the method comprising:
providing a pillar having a vertical rotational axis;
connecting a plurality of blades to the pillar, each of the plurality of blades comprising a plurality of flaps that open or close in response to a wind direction; and
connecting a control system to the plurality of blades, the control system configured to control the extent of opening and closing of the flaps based on the wind direction and wind intensity.

11. The method of claim 10, further comprising:
connecting a camshaft to the plurality of blades by means of a spring resistor, the camshaft configured to open or close the flaps based on the resistance of the spring resistor.

12. The method of claim 10, further comprising:
connecting the camshaft to the pillar supporting the plurality of blades.

13. The method of claim 10, further comprising:
connecting a power generator to the vertical rotational axis of the pillar to generate power based on the rotation of the blades, and store the power.

14. The method of claim 10, further comprising:
connecting an electrical system substation to the power generator using a plurality of power lines.

15. The method of claim 10, further comprising:
producing the plurality of blades from metal, fiber reinforced composite, or a polymeric material.

16. The method of claim 10, further comprising:
producing the plurality of flaps from metal, fiber reinforced composite, or a polymeric material.

17. The method of claim 11, wherein the resistance of the spring resistor is less than 0.01 lbf.

18. The method of claim 10, wherein the plurality of flaps are rectangular, circular, triangular, oval, or square shaped.
